(19) United States
(12) Patent Application Publication
(10) Pub. No.: US 2026/0303240 A1
(43) Pub. Date: Oct. 1, 2026

(54) ARTIFICIAL INTELLIGENCE-AIDED CHANNEL ESTIMATION

(71) Applicant: Samsung Electronics Co., Ltd., Suwon-si (KR)

(72) Inventors: Mandar Kulkarni, Bridgewater, NJ (US); Yeqing Hu, Allen, TX (US); Pranav Madadi, Sunnyvale, CA (US); Russell Douglas Ford, Campbell, CA (US); William Xia, Ozone Park, NY (US); Fan Zhang, Plano, TX (US); Yang Li, Plano, TX (US); Yan Xin, Princeton, NJ (US); Jianzhong Zhang, Dallas, TX (US)

(21) Appl. No.: 19/565,141

(22) Filed: Mar. 12, 2026

Related U.S. Application Data
(60) Provisional application No. 63/774,689, filed on Mar. 19, 2025.

(51) Int. Cl. H04B 17/309; H04B 17/21; H04B 17/391

(52) U.S. Cl. CPC H04B 17/346; H04B 17/21; H04B 17/391

(57) ABSTRACT

A method includes: receiving, by a first electronic device located in a first site, a signal from a second electronic device over a channel; obtaining, by the first electronic device, a noisy channel estimate based on the received signal using a linear estimator; preprocessing, by the first electronic device, the noisy channel estimate to remove at least one of an anomaly, a multiuser interference, or a timing offset; and estimating, by the first electronic device, the channel using an artificial intelligence channel estimation model.

### CROSS-REFERENCE TO RELATED APPLICATION AND CLAIM OF PRIORITY

The present application claims priority under 35 U.S.C. § 119(e) to U.S. Provisional Patent Application No. 63/774,689 filed on Mar. 19, 2025, which is hereby incorporated by reference in its entirety.

### TECHNICAL FIELD

This disclosure relates generally to wireless communication systems. More specifically, this disclosure relates to apparatuses and methods for artificial intelligence (AI) aided channel estimation in wireless communication systems.

### BACKGROUND

The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage are of paramount importance.

5th generation (5G) or new radio (NR) mobile communications is recently gathering increased momentum with all the worldwide technical activities on the various candidate technologies from industry and academia. The candidate enablers for the 5G/NR mobile communications include massive antenna technologies, from legacy cellular frequency bands up to high frequencies, to provide beamforming gain and support increased capacity, new waveform (e.g., a new radio access technology (RAT)) to flexibly accommodate various services/applications with different requirements, new multiple access schemes to support massive connections, and so on.

### SUMMARY

This disclosure provides an ecosystem for AI aided channel estimation in wireless communication systems.

In one embodiment, a method includes: receiving, by a first electronic device located in a first site, a signal from a second electronic device over a channel; obtaining, by the first electronic device, a noisy channel estimate based on the received signal using a linear estimator; preprocessing, by the first electronic device, the noisy channel estimate to remove at least one of an anomaly, a multiuser interference (MUI), or a timing offset (TO); and estimating, by the first electronic device, the channel using an artificial intelligence channel estimation (AI CE) model.

In another embodiment, a first electric device is located at a first site and includes: a memory and a processor operably coupled to the memory. The processor is configured to: receive, a signal from a second electronic device over a channel; obtain a noisy channel estimate based on the received signal using a linear estimator; preprocess the noisy channel estimate to remove at least one of an anomaly, a MUI, or a TO; and estimating the channel using an AI CE model.

In yet another embodiment, a non-transitory computer readable medium embodying a computer program is provided. The computer program includes program code that, when executed by a processor of a first electronic device, causes the first electronic device to: receive, a signal from a second electronic device over a channel; obtain a noisy channel estimate based on the received signal using a linear estimator; preprocess the noisy channel estimate to remove at least one of an anomaly, a MUI, or a TO; and estimating the channel using an AI CE model.

Other technical features may be readily apparent to one skilled in the art from the following FIGURES, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of this disclosure and its advantages, reference is now made to the following description, taken in conjunction with the accompanying drawings, in which:

FIG. 1 illustrates an example wireless network according to embodiments of the present disclosure;

FIG. 2 illustrates an example base station according to embodiments of the present disclosure;

FIG. 3 illustrates an example user equipment according to embodiments of the present disclosure;

FIG. 4 illustrates an example network device according to embodiment of the present disclosure;

FIG. 5 illustrates an example SRS-based CE procedure according to example embodiments of the present disclosure;

FIG. 6 illustrates an example frequency operation mode for transmitting SRS according to example embodiments of the present disclosure;

FIG. 7 illustrates an example UL OFDM slot structure according to embodiments of the present disclosure;

FIG. 8 illustrates example DMRS symbol locations in an unlink slot in accordance with example embodiments of the present disclosure;

FIG. 9 illustrates an example TO impairment according to embodiments of the present disclosure;

FIG. 10 illustrates an example end-to-end architecture for PUSCH AI CE in wireless communication systems in accordance with example embodiments of the present disclosure;

FIG. 11 illustrates an example anomaly in subcarrier tones in accordance with example embodiments of the present disclosure;

FIG. 12 illustrates an adaptive time windowing for CS-2 case in accordance with example embodiments of the present disclosure;

FIG. 13 illustrates an example end-to-end architecture for sounding reference signal based AI CE in accordance with example embodiments of the present disclosure;

FIG. 14 illustrates another example end-to-end architecture for SRS based AI CE in accordance with example embodiments of the present disclosure;

FIGS. 15 and 16 illustrate example issues with a center of gravity (CoG) timing estimation algorithm in accordance with example embodiments of the present disclosure;

FIG. 17 illustrates example modified CoG timing estimation algorithms in accordance with example embodiments of the present disclosure;

FIG. 18 illustrates an example GAN to aid with the AI CE model deployment in the wireless communication systems in accordance with example embodiments of the present disclosure; and

FIG. 19 illustrates an example flow chart for an AI-aided channel estimation method 1900 according to embodiments of the present disclosure.

### DETAILED DESCRIPTION

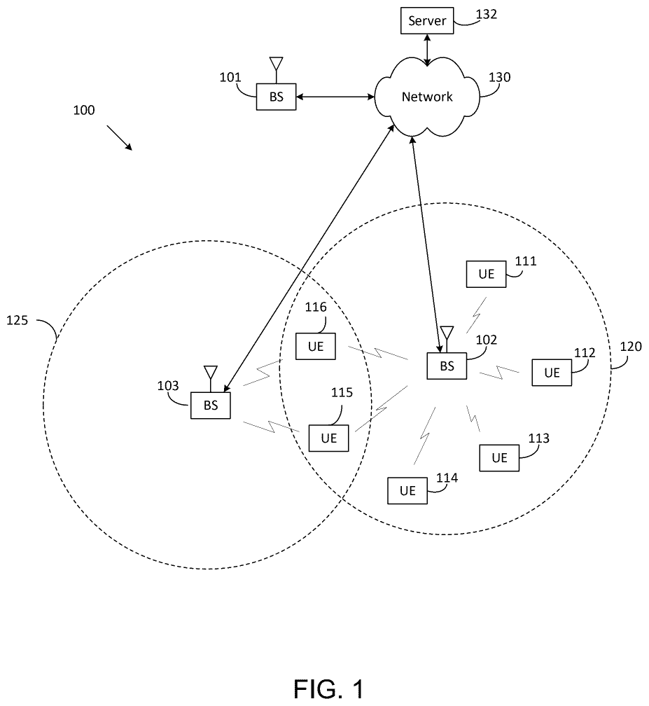

FIGS. 1 through 19, discussed below, and the various embodiments used to describe the principles of this disclosure in this patent document are by way of illustration only and should not be construed in any way to limit the scope of the disclosure. Those skilled in the art will understand that the principles of this disclosure may be implemented in any suitably arranged wireless communication system.

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mmWave) bands, e.g., 28 GHz or 60 GHz bands, so as to accomplish higher data rates or in lower frequency bands, such as 6 GHZ, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancelation and the like.

The discussion of 5G systems and frequency bands associated therewith is for reference as certain embodiments of the present disclosure may be implemented in 5G systems. However, the present disclosure is not limited to 5G systems or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

FIGS. 1-4 below describe various embodiments implemented in wireless communications systems and with the use of orthogonal frequency division multiplexing (OFDM) or orthogonal frequency division multiple access (OFDMA) communication techniques. The descriptions of FIGS. 1-4 are not meant to imply physical or architectural limitations to the manner in which different embodiments may be implemented. Different embodiments of the present disclosure may be implemented in any suitably arranged communications system.

FIG. 1 illustrates an example wireless network 100 according to embodiments of the present disclosure. The embodiment of the wireless network 100 shown in FIG. 1 is for illustration only. Other embodiments of the wireless network 100 could be used without departing from the scope of this disclosure.

As shown in FIG. 1, the wireless network 100 includes a gNB (e.g., base station, BS) 101, a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

The wireless network 100 may be an AI-based cellular system. As such, the at least one network 130 may be operably coupled to a network device (e.g., without limitation, a server) 132 configured to, for example and without limitation, receive data from the gNBs 101-103 via backhaul/network interfaces and train and/or test an AI model to perform channel estimation. The server 132 may represent one or more servers, and each server 132 includes a suitable computing or processing device for training and/or testing the AI model. Each server 132 could, for example, include one or more processing devices, one or more memories storing instructions and data, and one or more network interfaces to receive the data. The AI model can then be trained, tested and deployed to effectively perform channel estimation for reliable and efficient communications in the wireless communication network 100.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3rd generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof, to support the gNB 101-103 for performing wireless communications tasks. In certain embodiments, one or more of the gNBs 101-103 include circuitry, programing, or a combination thereof, to perform AI-based channel estimation (CE) in wireless communication systems.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

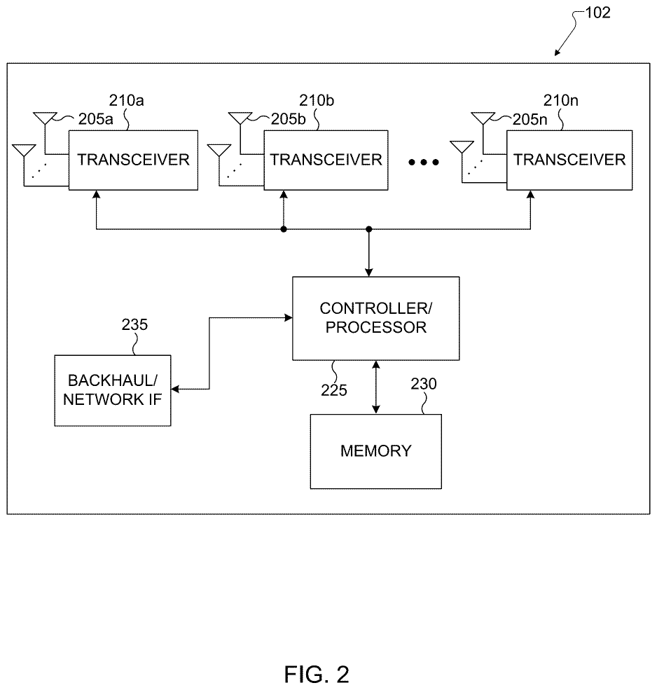

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming RF signals, such as signals transmitted by UEs in the network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-convert the baseband or IF signals to RF signals that are transmitted via the antennas 205a-205n.

The controller/processor 225 can include one or more processors or other processing devices that control the overall operation of the gNB 102. For example, the controller/processor 225 could control the reception of UL channel signals and the transmission of DL channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the gNB 102 by the controller/processor 225.

The controller/processor 225 is also capable of executing programs and other processes resident in the memory 230, such as an OS and, for example, processes to perform AI aided channel estimation as discussed further in detail below. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

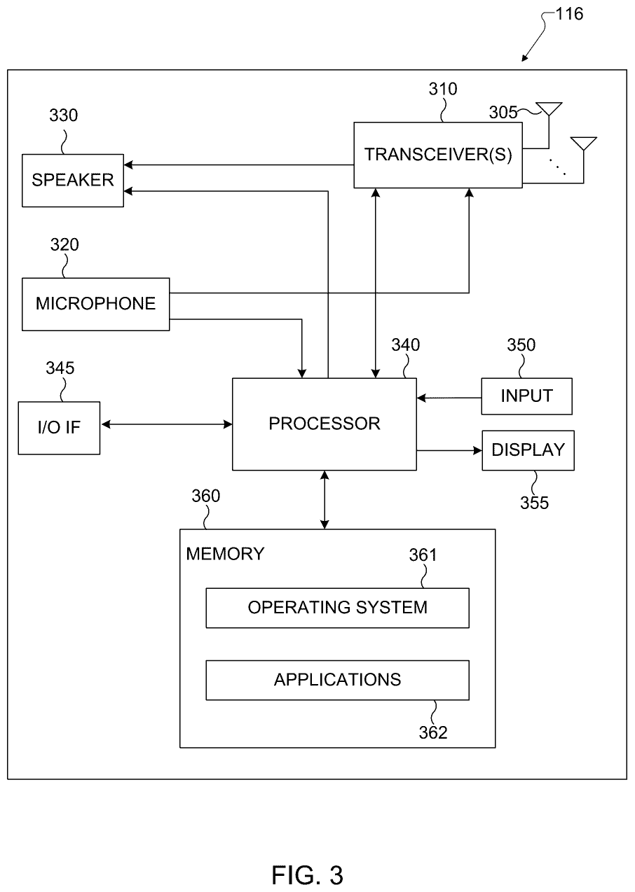

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives, from the antenna 305, an incoming RF signal transmitted by a gNB of the network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360, for example, processes to support the AI-aided channel estimation method as discussed in greater detail below. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

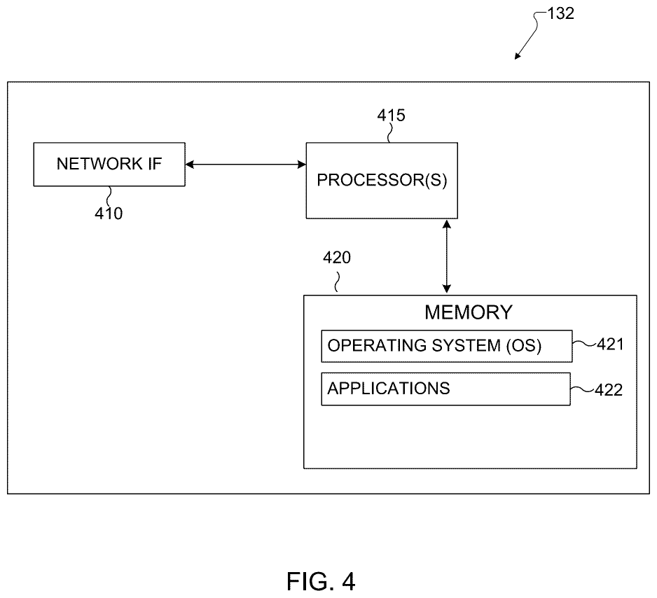

FIG. 4 illustrates an example network server 132 according to embodiments of the present disclosure. The embodiment of the server 132 illustrated in FIG. 4 is for illustration only. Different embodiments of servers 132 could be used without departing from the scope of this disclosure.

The server 132 may be a computing device including at least a network interface 410, a processor 415 and a memory 420. The network interface 410 may support communications over any suitable wired or wireless connection(s). It may include any suitable structure supporting communications over a wired or wireless connection, such as an Ethernet or transceiver. The network interface 410 may be, for example and without limitation, network interface cards (NICs) or network ports. The server 132 may receive data from the gNBs 101-103 via the network interface 410, the UEs 111-116 via the gNBs 101-103, or any other appropriate sources. The server 132 may also train and/or test an AI model to perform channel estimation as discussed further in detail below.

The processor 415 is coupled to the network interface 410 and can include one or more processors or other processing devices. The processor 415 can execute instructions that are stored in the memory 420, such as the OS 421 in order to control the overall operation of the server 132. The processor 415 can include any suitable number(s) and type(s) of processors or other devices in any suitable arrangement. For example, in certain embodiments, the processor 415 includes at least one microprocessor or microcontroller. Example types of processor 415 include microprocessors, microcontrollers, digital signal processors, field programmable gate arrays, application specific integrated circuits, and discrete circuitry. In certain embodiments, the processor 415 can include a neural network such as an AI CE model as well as a CPU, a GPU or a tensor processing unit (TPU) that provides significant computational resources required for training the AI CE model.

The processor 415 is also capable of executing other processes and programs resident in the memory 420, such as operations that receive and store data. As described in greater detail below, the processor 415 may execute processes to train and/or test an AI CE model to perform channel estimation in the wireless communication systems. The processor 415 can move data into or out of the memory 420 as required by an executing process. In certain embodiments, the processor 415 is configured to execute the one or more applications 422 based on the OS 421 or in response to signals received from external source(s) or an operator. Example applications 422 can include an AI training application for the AI model.

The memory 420 is coupled to the processor 415. Part of the memory 420 could include a RAM, and another part of the memory 420 could include a Flash memory or other ROM. The memory 420 can include persistent storage (not shown) that represents any structure(s) capable of storing and facilitating retrieval of information (such as data, program code, and/or other suitable information). The memory 420 can contain one or more components or devices supporting longer-term storage of data, such as a read only memory, hard drive, Flash memory, or optical disc.

Although FIG. 4 illustrates one example of the server 132, various changes can be made to FIG. 4. For example, various components in FIG. 4 can be combined, further subdivided, or omitted and additional components can be added according to particular needs. As a particular example, the processor 415 can be divided into multiple processors, such as one or more central processing units (CPUs), one or more graphics processing units (GPUs), one or more neural networks, and the like.

AI has been increasingly integrated in the modern wireless communication such as those described regarding FIGS. 1-4, to enhance performance of critical wireless communication tasks. Recently, native AI algorithms for physical and medium access layer have emerged as candidates to drive the next generation cellular network design. However, such native AI algorithms have yet to be implemented in the commercial wireless communication devices due to numerous engineering problems that need to be solved before such implementation.

These engineering problems may include:
Ability to reflect the simulation gains which may be in terms of the quality of channel estimation to throughput gains that may be meaningful by looking at end to end system integration
Ubiquitous gains of AI CE with a generalized model and not on specific test cases or scenarios
Increased compute and need for GPU or specialized field programmable gate array (FPGA) hardware architecture that may make it harder to make a persuasive case
Supporting all practical configurations relevant for commercialization.

With the continued interest in the industry to commercialize AI for radio access network and with this thrust in the industry and research community, some breakthroughs have been made toward understanding and resolving these bottlenecks.

The present disclosure resolves some of these bottlenecks by providing an end-to-end architecture for PUSCH AI CE that includes CFAR for removing anomalies in the frequency domain channel, MUI removal, adaptive time domain windowing after timing estimation and compensation, power normalization, adaptive resource block size dependent AI model, and time domain interpolation of equalizer weights from pilot to data symbols. This PUSCH AI CE end-to-end architecture may not only offer robustness to radio frequency impairments such as TO, MUI and DC nulling, but also provide handling mechanisms for different allocated resource block (RB) sizes, equalizer and coding designs for extracting significant benefits from the AI-based CE (also referred to herein as AI CE). For instance, an example end to end architecture for sounding reference signals (SRS) AI CE in accordance with the present disclosure may provide, in addition to the robustness to the radio frequency impairments, significant performance benefits through an adaptive sliding window approach for removing cyclic shift multiuser interference.

Further, the present disclosure also provides training methods for the PUSCH AI CE including (a) a transfer learning approach to use limited field data to adapt to site specific preprocessing tuning and data distribution, (b) utilizing multiple sources of labels for training with field data, and (c) a modulation dependent loss function.

In addition, the present disclosure also provides forecasting tools and methods for deploying an AI CE model in the network and recommending whether to deploy an FPGA or GPU enabled AI CE, and identify which new candidate sites may be similar to the initial example sites with the AI CE model utilizing a GAN.

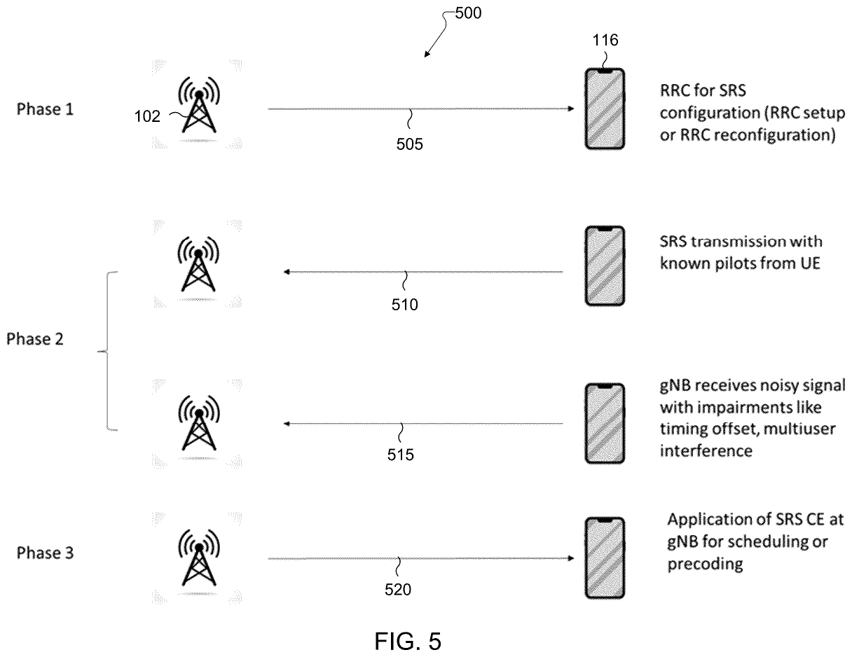

FIGS. 5-19 illustrate non-limiting embodiments of the ecosystem for AI-aided channel estimation, the resultant benefits, and related concepts thereof in greater detail in accordance with the present disclosure.

FIG. 5 illustrates an example SRS-based CE procedure 500 according to example embodiments of the present disclosure. The example procedure 500 shown in FIG. 5 is for illustration only. One or more of the components illustrated in FIG. 5 may be implemented in specialized circuitry configured to perform the noted functions or one or more of the components may be implemented by one or more processors executing instructions to perform the noted functions. Other embodiments of SRS-based CE could be used without departing from the scope of this disclosure.

SRS and demodulation reference signals (DMRS) are pilots used for CE at a radio access network (RAN) for uplink and downlink. CE may be performed utilizing the pilots leveraging a variant of minimum mean squared error estimate (MMSE) or using a moving average algorithm. These algorithms may be outperformed by neural-network based AI algorithms. However, integrating such neural network-based algorithms into a RAN may be beneficial.

The example procedure 500 of FIG. 5 illustrates a three-phased SRS-based CE. SRS are uplink signals transmitted by a UE for enabling CE over different frequency subcarriers at a base station (gNB).

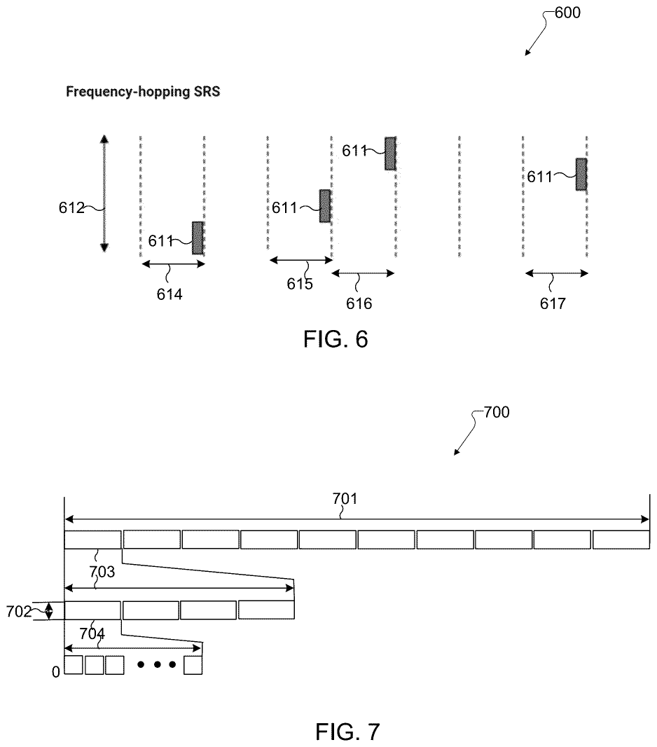

In phase 1, a base station (e.g., without limitation, the base station 101-103 of FIGS. 1 and 2) may transmit an RRC signal 505 for configuring or reconfiguring SRS in terms of a total number of resource blocks (RBs) for SRS transmission, a frequency bandwidth of operation, a frequency hopping option, and transmission comb and cyclic shift information. As illustrated in FIG. 6, the frequency hopping option may allow the UEs (e.g., without limitation, the UEs 111-116 of FIGS. 1 and 3) to transmit SRSs in a frequency hopping mode when the channels may have poor conditions. The transmission comb and cyclic shift may provide ways to multiplex multiple users. Cyclic shift may indicate the number of users which can be scheduled at the same RBs simultaneously, exploiting the delay domain orthogonality of the signal. Transmission comb N may indicate whether the SRS may be transmitted over every N^{th} subcarrier.

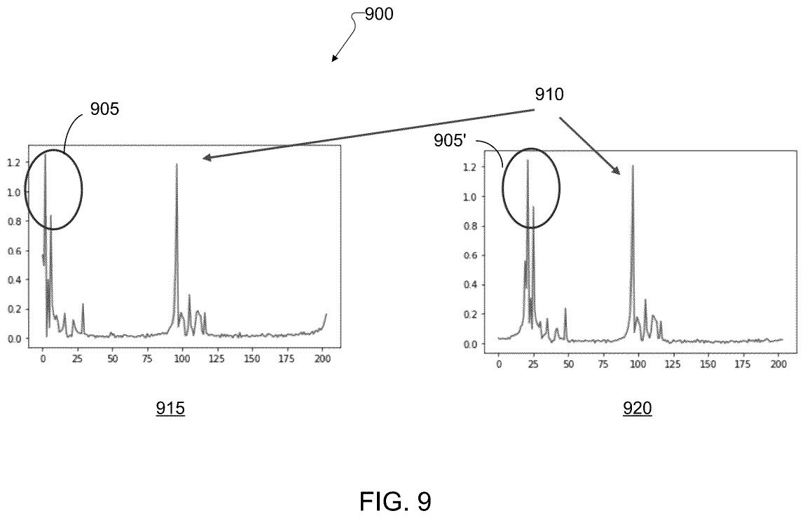

In phase 2, the UEs 116 may transmit SRSs 510 as per corresponding configuration from the serving base station 102, and the base station 102 may receive noisy versions 515 of the SRSs. The noisy signal may be impaired with, e.g., without limitation, MUI or TO (as discussed in FIG. 9). The base station 102 may then perform channel estimation based on the received signals and its knowledge of known pilot symbols that were transmitted.

In phase 3, the base station 102 may utilize the estimated channels from the SRSs for the following example applications:
1. Uplink channel aware scheduling and link adaptation:
   a. The packet scheduler identifying an optimal set of RBs to schedule the user
   b. Utilizing an uplink signal to interference plus noise ratio (estimated from the estimated channel) as an input for link adaptation (i.e. modulation and coding scheme (MCS) also known as MCS adjustment).
2. Downlink application: If the UE has an antenna switching capability to use the RX antennas for TX and vice versa, then for a TDD system the channel estimated using the uplink SRS can also be used for downlink. In this case, the UE may actually use the antennas it will be using for downlink reception for transmitting the uplink SRS signals leveraging the antenna switching.
3. Uplink beam management: A user may be allowed to choose an optimal uplink beam at an optimal station using the estimated channel.

Although the user specific reference signals may be transmitted over the entire bandwidth of operation, the channels may have a bad channel quality, requiring different operation modes as illustrated in FIG. 6.

FIG. 6 illustrates an example frequency operation mode 600 for transmitting SRS according to example embodiments of the present disclosure. The example frequency operation mode 600 shown in FIG. 6 is for illustration only. One or more of the components illustrated in FIG. 6 may be implemented in specialized circuitry configured to perform the noted functions or one or more of the components may be implemented by one or more processors executing instructions to perform the noted functions. Other embodiments of frequency operation modes preparation could be used without departing from the scope of this disclosure.

When the channel conditions are poor, the example frequency hopping mode 600 may be utilized for transmitting the SRS 611. The frequency hopping mode option may allow the UEs to enable “frequency hopping,” where the entire bandwidth 612 of operation may be covered not in a single OFDM subframe but across multiple subframes 614-617. An example OFDM slot structure is described in FIG. 7.

FIG. 7 illustrates an example UL OFDM slot structure 700 according to embodiments of the present disclosure. The example slot structure 700 shown in FIG. 7 is for illustration only. For example, different numerologies with different subcarrier spacings, slot duration and number of slots per subframe may be supported. Other embodiments of uplink (UL) OFDM slot structures could be used without departing from the scope of this disclosure.

The SRS may be transmitted via its allocated resource elements within the time-frequency grid having a number of resource elements (REs). An RE may comprise one OFDM symbol period and one subcarrier, where the symbol period and subcarrier spacing are inversely related.

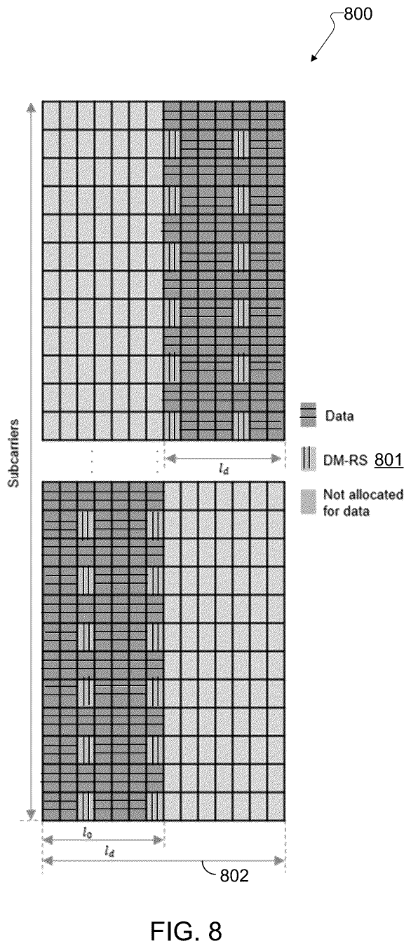

In FIG. 7, the x-axis represents time (a radio frame 701 including subframes 703, each subframe including slots 704, each slot including 14 symbols) and the y-axis represents orthogonal and equally spaced subcarriers 702. An OFDM symbol may be utilized for the SRS and subcarriers 702 may be allocated to carry the SRS. An OFDM symbol may also be utilized for DMRS as shown in FIG. 8. The SRS may be transmitted in 1, 2 or 4 consecutive slots and within the last 6 OFDM symbols of a UL slot 704. The SRS may cover the entire bandwidth and each SRS may have a comb structure. In LTE, a comb-2 structure is supported, and in 5G/NR, a comb-2 structure and a comb-4 structure are supported for each SRS. In FIG. 7, the SRS has the comb-2 structure.

The SRS pilots may be first transmitted by a UE (e.g., a UE 111-116 of FIGS. 1 and 3) and noisy SRSs may be received at a base station (e.g., a gNB 101-103 of FIGS. 1 and 2). The base station may next perform channel estimation based on the received SRSs. The base station may then utilize the estimated wireless channel for, e.g., uplink channel aware scheduling, precoder matrix index (PMI) selection, etc. Thus, channel estimation (e.g., SRS-based channel estimation) may play a critical role in increasing throughput (Tput) in wireless communication systems.

FIG. 8 illustrates example DMRS symbol locations 800 in a UL slot 801 in accordance with example embodiments of the present disclosure. The example locations 800 shown in FIG. 8 are for illustration only. Other embodiments of DMRS symbol locations could be used without departing from the scope of this disclosure.

DMRS pilots may be utilized in CE for demodulation purpose unlike the SRS CE which has applications in precoding and scheduling. The design and mapping of each DMRS pilot may be specific to the application in PUSCH or PDSCH. In PUSCH, DMRS may be based on either DFT-S-OFDM or CP-OFDM depending on whether transform precoding is enabled or disabled in a 5G NR receiver. Gold sequence may be utilized as pilots in CP-OFDM whereas Zadoff Chu sequence may be utilized as pilots in DFT-S-OFDM. DMRS may be present only on RBs allocated for PUSCH and the DMRS structure may be designed to support multiple configurations and use cases.

As shown in FIG. 8, example configurable parameters may include: DMRS symbol locations, mapping type, intra slot frequency hopping, DMRS type A position, DMRS length, etc.

In FIG. 8, the example locations 800 for DMRS symbols 801 may be in a slot 802 based on an intra frequency hopping.

CE may be defined as estimating channel H_{N}_{_{sc}}_{×N}_{ₐₙₜ} given received noisy pilot (PUSCH DMRS or SRS) signals Y_{N}_{_{sc}}_{×N}_{ₐₙₜ}. The transmitted pilots may contain known Zadoff Chu sequences X_{N}_{_{sc}}_{×N}_{ₐₙₜ}. The received noisy signals may be provided as follows:

$${Y}_{{N}_{s c} \times {N}_{a n t}} = {H}_{{N}_{s c} \times {N}_{a n t}} o {X}_{{N}_{s c} \times {N}_{a n t}} + {N}_{{N}_{s c} \times {N}_{a n t}} \qquad ( Eq . 1 )$$

Here, o represents an element wise multiplication. After the Zadoff Chu sequence removal or decorrelation at the receiver, the least squares estimate of the channel Z=Y/X=H+N (the element wise division) may be obtained. This noisy channel estimate Z is then denoised to obtain noiseless channel H. This may be executed utilizing linear minimum mean squared error estimate (LMMSE). However, the complexity of the LMMSE may become prohibitively high as the antenna dimensions and subcarrier dimensions increase. In some examples, a lower complexity moving average (MA) algorithm, which exploits a high correlation across subcarriers to denoise a wireless channel, may be utilized.

MA solutions may be alternatives to the LMMSE that have relatively a lower complexity. For AI enabled denoising task, a key difference from algorithm perspective may be the need to support dynamically allocated bandwidths with PUSCH DMRS CE unlike in SRS CE.

FIG. 9 illustrates an example TO impairment 900 according to embodiments of the present disclosure. The example TO impairment 900 shown in FIG. 9 is for illustration only. Other embodiments of TO impairment could be used without departing from the scope of this disclosure.

A base station (e.g., the gNB 101-103 of FIGS. 1-2) may transmit timing advance (TA) command to UEs (e.g., the UEs 111-116 of FIGS. 1 and 3) so that the signal from all of the UEs may arrive synchronously across different RBs. TA may be utilized to control the UL transmission of UE including the SRS, PUSCH or PUCCH. TA may ensure that data from all of the UEs arrive synchronously at the gNB irrespective of their time of flight.

For example, if there is a cyclic shift configuration, a UE signal may be expected to arrive at a predefined delay than start of the symbol. However, due to hardware impairments like a clock synchronization between the UE and the gNB, UE mobility, or inaccuracy of the TA command, the signal may not exactly arrive at the expected time. The offset between the actual time at which the signal arrives and the expected time at which the signal should have arrived is called the TO.

In FIG. 9, the TO impairment 900 in a cyclic-shift (CS) 2 scenario is illustrated. That is, there may be one interfering UE 910 for a target channel. In the graph 915, there may be no TO for the SRS 905 transmitted over the target channel. In graph 920, the SRS 905′ transmitted over the target channel may encounter a 780 ns TO (40.85 ns×19 delay taps) impairment. The interfering UE signal 910 may be separated from a target channel in a delay domain by dividing the total OFDM symbol duration for the SRS transmission into equal halves.

It is noted that in the present disclosure, the key performance indicator (KPI) may be the normalized mean squared error (NMSE) in a dB scale. Hence, the channel estimation performance may be inversely proportional to the KPI. Block error rate (BLER) and throughput may also be utilized as KPIs.

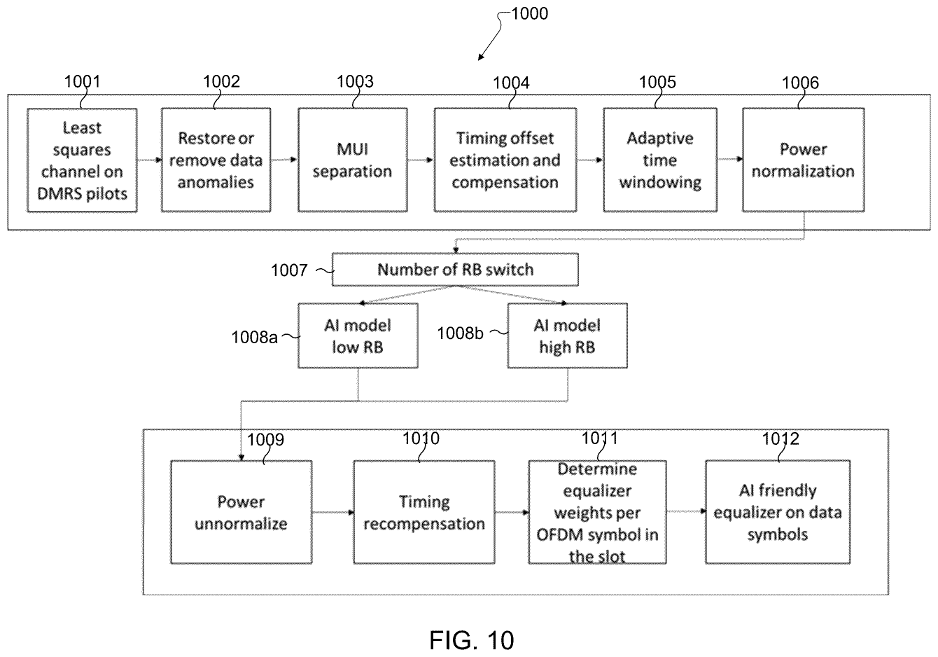

Now, the AI-based channel estimation method and apparatus according to the present disclosure, which resolve some of the aforementioned engineering problems, are discussed further in detail with reference to FIGS. 10-19.

FIG. 10 illustrates an example end-to-end architecture 1000 for a PUSCH AI CE method in wireless communication systems in accordance with example embodiments of the present disclosure. The example architecture shown in FIG. 10 is for illustration only, and could have the same or similar configuration. One or more of the components illustrated in FIG. 10 may be implemented in specialized circuitry configured to perform the noted functions or one or more of the components may be implemented by one or more processors executing instructions to perform the noted functions. Other embodiments of the end-to-end PUSCH AI CE architecture in accordance with the present disclosure could be used without departing from the scope of this disclosure. FIG. 10 does not limit the scope of this disclosure to any particular embodiment of the end-to-end PUSCH AI CE architecture.

The example end-to-end architecture 1000 of FIG. 10 may include a noisy channel estimation module 1001. The noisy channel estimation module 1001 may utilize the DMRS pilots to first obtain least squares channel estimate. This least square channel estimate may be noisy and the goal of the AI CE may be to denoise this coarse channel estimate. In post-processing, an AI CE friendly equalizer may be utilized.

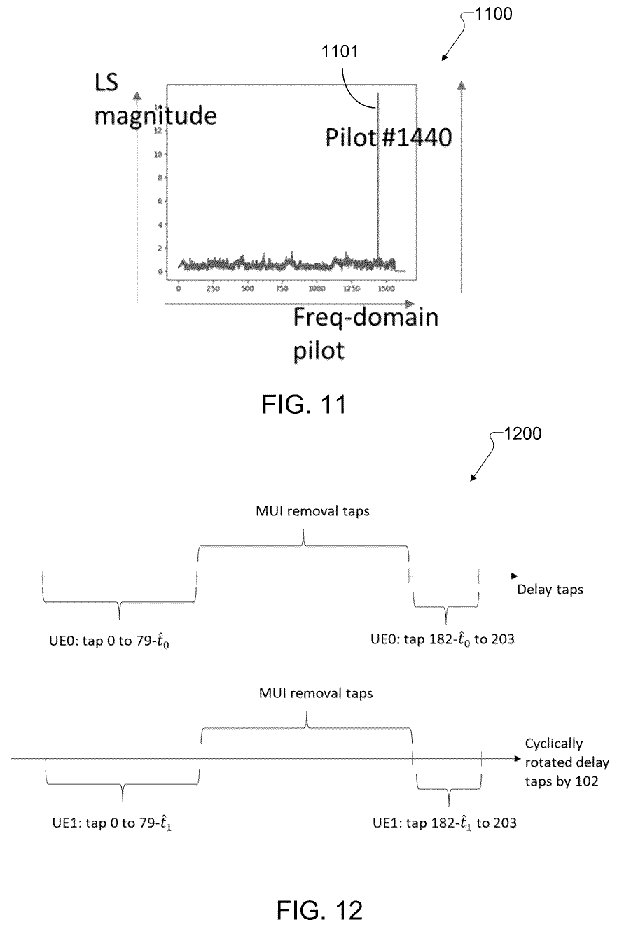

An anomaly mitigation module 1002 may then restore or remove anomalies in the data. Restoring anomalies may imply identifying anomalies and then correcting the data. Removing anomalies may imply completely dropping the data sample if the anomalies are identified. For instance, one anomaly occurring due to hardware imperfections may include an anomaly resulting due to sudden undesirable spikes at some pilot tones and to restore such abnormality in some specific tones, constant false alarm rate (CFAR) algorithm may be utilized as described in FIG. 11.

There may be other types of anomalies that may need to be removed and cannot be restored. For example, the system may receive not a number type wasteful values or may receive data with an undesired configuration not supported by the architecture 1000. As an example, where the architecture 1000 supports 2 or 3 DMRS symbol positions, if an outlier receive slot is received with many more or less DMRS symbols, then the receive slot may be completely dropped.

Once the data is restored or removed with the anomalies, it may be determined that the slot may be processed for performing AI CE. A separation module 1003 may perform MUI separation. The DMRS symbols may carry pilots for more than one user or more than one data stream (spatial multiplexing) through cyclic shifting. Thus, the first step may be to remove the data streams that are multiplexed with each other. This may include using a multi-cyclic shift (CS) separator that leverages the cyclic shift sequences. The multi-CS separator may essentially solve a system of equations to extract the contributions from individual data streams multiplexed together assuming no TO on each data stream. Thus, this may be only a coarse separation, and a final multi-CS separation may be performed later in the preprocessing after the timing estimates are obtained. The multi-CS separator performed with 0 TO for all data streams may look like H=A⁻¹G, where G=[g₁, . . . , g_{N}] are N timestamps (can be multiple OFDM symbols and not necessarily consecutive as it depends on scheduling) for which the same multiplexed combination of data streams was received, H=[h₁, . . . , h_{N}] are the separated N data streams and A is a N×N matrix that contains the cyclic shift sequences for the N streams. Each of gᵢ, hᵢ may have dimension 1×Nₐₙₜ. The operation may be performed per physical resource block (PRB). For instance, for CS-2 case A=[1, −1; 1, 1] is the 2×2 matrix.

Once the separation of data streams is performed, a TO compensation module 1004 may compute TO for each stream and compensate for the TO utilizing the following equations. For a fixed antenna, the module 1004 may obtain TO estimate t from the frequency domain signal X_{f}. For a given lag setting l, the module 1004 may compute the average of

$${X}_{f , k} {X}_{f , ℓ + k}^{*}$$

over k to obtain exp (j2π [symbol] Δ_{f}τ). The lag may be set around 2 to 4, and Δ_{f} may be a subcarrier spacing. The exp (j2π [symbol] Δ_{f}τ) may be used to recover the timing estimate τ. The timing compensation may be then performed using the following equation

$${X}_{f}^{i} = {X}_{f} exp ( j 2 π {Δ}_{f} {τ}_{i} ) ,$$

where i is antenna index. In then performed using the following equation an implementation of a joint antenna timing compensation, the Ti may be averaged before the timing compensation.

A windowing module 1005 may perform an adaptive time windowing on the original multiplexed channel as illustrated in FIG. 12. Utilizing an adaptive windowing instead of a fixed windowing may help improve performance.

A normalizer 1006 may perform power normalization. For example, the input channel per receive slot may have dimensions Nₚᵢₗₒₜₛ×Nₐₙₜ×N_{DMRS}×2, where Nₚᵢₗₒₜₛ is the total number of subcarriers (depends on UE resource block allocation), Nₐₙₜ is the number of receive antennas, N_{DMRS} is the number of DMRS symbols in a receive slot and 2 to represent the complex channel with real/imaginary. The power normalization may ensure that per receive slot the average power across all of the dimensions is always unit.

Multiple AI models may be deployed to handle different scenarios. For instance, a different AI model 1008a, 1008b may be utilized for a different RB allocation size. There may be a hard threshold on the number of RBs below which a certain AI model is triggered over another. An RB switch 1007 may be utilized to select an AI model based on the threshold. For example, the RB switch 1007 may switch an AI model 1008a trained with a low number of the RBs if the RB allocation size is smaller than the threshold. Alternatively, the RB switch 1007 may switch an AI model 1008b trained with a higher number of RBs if the RB allocation size is greater than the threshold. In some example, both AI models 1008a, 1008b may be utilized simultaneously. The two AI models 1008a, 1008b may not necessarily have the same architecture. Similarly, an exemplary switch in the AI models may be utilized to select the AI models based on the number of DMRS symbols in the receive slot.

A denormalizer 1009 may perform power denormalization. The output of the AI CE 1008a, 1008b may be power unnormalized (denormalized) to bring back to the original power levels before the preprocessing. A recompensation module 1010 may perform timing recompensation to restore the original timing in the received channel. The estimated channel in this way may be then fed to an equalizer 1011 along with data symbols.

Equalizers may include MMSE, maximum ratio combining (MRC) or zero forcing (ZF). Let H be the estimated channel utilized for determining the equalizer weights W.

$$MRC equalizer : W = {H}^{*} \qquad Eq . ( 2 )$$

$$Zero forcing equalizer : W = {H}^{+} , where {H}^{+} is the pseudo inverse of the channel H$$

$$MMSE equalizer : W = {{H}^{⋆} ( {HH}^{*} + I )}^{- 1}$$

The equalizer weights may be determined using the estimated channel per DMRS symbol location and the weights may be then utilized together to perform equalization of the data symbols. At a high level, there may be various ways: interpolate the equalizer weights to the data symbols, or interpolate the estimated channel first and then find the equalizer weights. Even within each, there may be multiple ways to perform equalization:
Fixed weights for all data symbols (example option 1) in a receive slot: In this case, a fixed DMRS symbol may be selected for estimating the weights in a slot. This may be performed by selecting (in some cases, for example, by always selecting) the first DMRS symbol or intelligently through an AI assisted method that selects an optimal DMRS symbol for equalization of all of the data symbols (for instance of the SNR levels being different on the different DMRS, a better channel estimation and thus equalizer weight accuracy on certain DMRS symbols may be expected).
Nearest neighbor DMRS equalization (example option 2): In this case, the nearest DMRS symbol may be utilized for estimating weights of a data symbol. In this version for different data symbols in a slot, there may be usage of different weights.
Linear interpolation of nearest two neighbors (example option 3): In this case, for every data symbol, the nearest two DMRS pilots may be utilized to interpolate either the channel or the weights directly to get the data symbol weights.
AI model for interpolating an optimal performance (example option 4): For example, where the linear interpolation may not be an optimal option, an AI architecture itself may be utilized to interpolating the channel or the weights. A super resolution network on high dimensional data like Restormer may be utilized, for this purpose.

In some instances, example options 1 and 2 may not be AI CE friendly. Thus, example option 3, if not example option 4, may be utilized. In one embodiment, Resnet and Nafnet may be used as two different candidate AI model architectures. The impact of the time domain interpolation for the AI CE performance may include NMSE with Nafnet being better than that with Resnet by 2 dB. However, with a suboptimal (non-AI CE friendly) equalizer, there may be losses with Nafnet. Gains may be seen with Nafnet by turning on time domain interpolation (TDI) for equalization.

Similar to AI CE friendly equalizer, AI CE aware coding may be expected where the code rate is lowered when the AI CE model is turned on.

The AI CE models 1008a, 1008b may be trained to empower the AI CE methods (DMRS or SRS based) from the lab to field performance. First issue to tackle may be the limited availability of the field training data. For this, a transfer learning approach in accordance with the present disclosure may be utilized. In this approach, a model may be trained first using 3GPP simulation data. Then, certain layers in the AI model architecture may be frozen and the model may be trained only the unfrozen layers with the limited available field data. The impact of transfer learning on normalized mean squared error performance may result in about 1-2 dB gain.

A next issue to be resolved may be the unavailability of accurate labels with the field data. In this case, one option may be to employ a non-AI alternative first to obtain the labels. However, this may limit the performance of the AI CE model to that of the non-AI alternative. There may be multiple sources of labels obtained from multiple non-AI approaches. In this case, the issue of how to leverage the multiple sources of label data for training may be resolved next. Assume there are two sources of labels L1 and L2. In this case, the training options may include (i.e., but is not limited to):
Example Method 1: Use L1 for training and validation, but ensure that the difference in testing performance with L2 is within a threshold
Example Method 2: Use L1 and L2 for training in alternate epochs so as not to overfit to any one of the two sources of labels.

For example method 1, it may be determined which label source may be primary for training and which one may be secondary for testing cross check. The labels may be selected based on the domain expertise on the implementation of these two training methods. For instance, one may be a 2D (two dimensional) LMMSE and the other may be MA implementation for CE. In this case, the 2D LMMSE may be selected as primary. However, another option may be to add sanity checks on the output of the two algorithms to select which may be primary. For instance, the one with the smaller noise floor may be selected the primary. The noise floor may be calculated knowing the delay taps, which may include only noise in controlled environment data collected or using ray tracing where the range of delay taps that do not include any signal. Another option may be to first select algorithm 1 (e.g., LMMSE) as L1 and algorithm 2 (e.g., MA) as L2, and also conduct an experiment with the algorithm 2 as L1 and the algorithm 1 as L2. Then, the combination that leads to a smaller testing loss difference may be utilized.

In one embodiment, a mixed modulation loss function design may be utilized for training. In this case, a different loss function may be utilized for each modulation scheme. The input to the loss function may include the output of the AI CE model and the labels. A definition of the distance between the two may be used for minimizing the loss. However, in the mixed modulation loss function design, the following may be utilized:
Take a flag that indicates the modulation scheme as input to the loss function. For instance, if M-QAM is the modulation scheme, a flag indicating this may be defined and input to the loss function. The constellation of M-QAM in the loss function definition, that already puts a good structure to the expected equalized output, may be utilized.
Take the AI CE model output for K data symbols as input to the channel estimation algorithm. Equalization may be performed as part of the loss function definition to obtain the estimated constellation points using the data symbols. These data symbols may be fixed for the entire training process or change for different epochs in the training.

The loss function may be:

$$ℓ ( {H}_{est , pilot} , {H}_{perfect , pilot} , modulationFlag , {H}_{noisy , pilot} )$$

Here, the H_{noisy,pilot} is the input to the AI CE model preprocessing (the least square channel estimate for instance) and is essentially the noisy estimate of the channel. The H_{est,pilot} is essentially the output of the AI CE model and the H_{perfect,pilot} contains the label. The loss function may be a sum of two different loss functions:

$$ℓ ( {H}_{est , pilot} , {H}_{perfect , pilot} , modulationFlag , {H}_{n o i s y , pilot} = {ℓ}_{1} ( {H}_{est , pilot} , {H}_{p erfect , pilot} ) + α {ℓ}_{2} , ( {H}_{est , pilot} , modulationFlag , {H}_{noisy , pilot} ) ,$$

where [symbol] is a loss function that minimizes the distance of the estimated channel with the perfect channel, [symbol] is an example loss function in accordance with the present disclosure and α is the weighting function that defines how much contribution from second loss may be considered. Example methods for [symbol] include the following:

$$1. \qquad {ℓ}_{1} = {\vert {H}_{est , pliot} - {H}_{perfect , pilot} \vert}^{2}$$

$$2. \qquad {ℓ}_{1} = {\vert {H}_{est , pilot} - {H}_{perfect , pilot} \vert}^{2} / {\vert {H}_{perfect , pilot} \vert}^{2}$$

The second term may be the example loss function and dependent on the QAM modulation order. Example methods for [symbol] may include:

$${ℓ}_{2} = {\vert {Q}_{est , pilot} - {Q}_{p erfect , pilot} \vert}^{2}$$

Here, Q refers to a constellation point for that pilot symbol considered in the loss function.

$${Q}_{est , pilot} = {W}_{est , pilot}^{*} {H}_{noisy , pilot}$$

whereas the Q_{perfect,pilot} is the closest constellation point to the estimated Q_{est,pilot} constellation point. W_{est,pilot} are the equalizer weights defined in Eq (2).

Since the loss function may be dependent on the modulation order which may actually be different in a training data set that considers adaptive MCS (modulation and coding scheme) levels, the loss function in accordance with the present disclosure may be called a mixed modulation loss function.

There may be more variations of this example method. In one embodiment, the loss function may not only depend on the modulation order, but also on the symbol location of the pilot. With moving users, the Doppler effect may cause the phase of the pilots to notably vary for the first and last OFDM symbol in a received slot. In this case, the data constellation may have a shift compared to the fixed M-QAM constellation. Thus, the location of the DMRS pilots may be another input to an optimal loss function for DMRS based PUSCH AI CE design.

FIG. 11 illustrates an example anomaly 1100 in subcarrier tones in accordance with example embodiments of the present disclosure. The example anomaly shown in FIG. 11 is for illustration only, and could have the same or similar configuration.

The example anomaly shown in FIG. 11 may include a sudden spike 1101 at a pilot tone (e.g., pilot #1440). This spike 1101 may occur due to hardware imperfections. Thus, the pilot tone 1440 may not carry any information about the channel, and thus undesirable.

To mitigate such anomaly, the CFAR may be utilized. This algorithm may be commonly utilized in radar applications for target detection in, e.g., the following steps:
For every frequency subcarrier tone s, compute the average amplitude of neighboring delay taps [s-N_{g}-N_{w}, S−N_{g}] and [s+N_{g}, s+N_{g}+N_{w}], where N_{g} is that guard window and N_{w} is the size of averaging window.
Subtract the average amplitude of the delay taps from the subcarrier amplitude s. If the difference exceeds a threshold T, then declare anomaly.
If the subcarrier s is an anomaly, then replace the subcarrier channel estimate with that of the neighborhood average.

If several anomalies are identified (e.g., >2% of the subcarriers), the sample may be dropped.

Note that the CFAR may be utilized in the AI CE pipeline (e.g., the end-to-end AI CE architecture 1000 of FIG. 10) and after the least squares estimation and before MUI removal.

Performing such abnormality removal may provide notable gains, e.g., with about 8% improvement in the BLER.

FIG. 12 illustrates an adaptive time windowing 1200 for CS-2 case in accordance with example embodiments of the present disclosure. The example time windowing shown in FIG. 12 is for illustration only, and could have the same or similar configuration. One or more of the components illustrated in FIG. 12 may be implemented in specialized circuitry configured to perform the noted functions or one or more of the components may be implemented by one or more processors executing instructions to perform the noted functions. Other embodiments of the adaptive time windowing could be used without departing from the scope of this disclosure.

Note that in the adaptive time windowing 1200, the separated MUI may not be utilized, which was used only for timing estimation purpose. The adaptive time windowing 1200 may be performed to remove the MUI interference completely and cleanly and also to help with denoising.

Although the time windowing may mainly remove MUI, even for CS-1 case a simple static window may help improve the normalized mean square error as it helps in a priori denoising of the channel input to the AI model. Most of the delay taps may be supposed to be 0 with sharp peaks on only a few delay taps. Approximately 1 dB NMSE gain may be obtained by zeroing some taps (e.g., taps 400 to 1300).

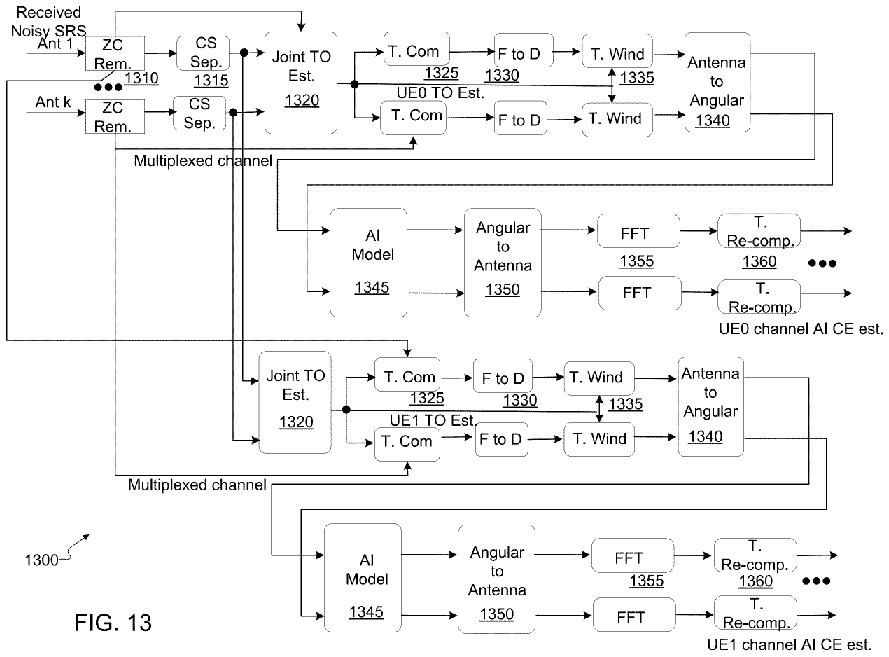

FIG. 13 illustrates an example end-to-end architecture 1300 for SRS based AI CE in accordance with example embodiments of the present disclosure. The example architecture shown in FIG. 13 is for illustration only, and could have the same or similar configuration. One or more of the components illustrated in FIG. 13 may be implemented in specialized circuitry configured to perform the noted functions or one or more of the components may be implemented by one or more processors executing instructions to perform the noted functions. Other embodiments of the adaptive time windowing could be used without departing from the scope of this disclosure.

In FIG. 13, a cyclic shift 2 use case is illustrated. Similar to the PUSCH AI CE architecture 1000 of FIG. 10, the first step may be to obtain the noisy least square channel estimate. For example, a remover 1310 may remove a Zadoff Chu (ZC) sequence to obtain the noisy channel estimate. A CS separator 1315 may then separate the multiplexed data streams (e.g., users or spatial multiplexing MIMO data streams). A joint TO estimator 1320 may perform TO estimation per data stream. A timing compensator 1325 may utilize the estimated TO for timing compensation directly on the multiplexed noisy least squares channel input. A converter 1330 may next convert the data from the frequency domain to the delay domain. Unlike the PUSCH AI CE, which had dependency of number of allocated resource blocks (RBs) per received slot, the SRS CE does not depend on number of RBs. Thus, the performance improvement from a delay domain AI model may be utilized for channel estimation. Once the channel is converted to the delay domain, a timing window 1335 may remove the MUI using time domain windowing. The adaptive windowing as illustrated in FIG. 12 may be utilized. A converter 1340 may convert the time compensated channel from the antenna to angular domain.

An AI CE model 1345 may denoise the time compensated channel. A converter 1350 may convert the denoised channel from the angular domain to the antenna domain. A converter 1355 may perform FFT to transform the denoised channel from the delay domain to the frequency domain. A recompensator 1355 may perform timing re-compensation and output a UE channel AI CE estimate.

Note that the SRS CE may not be used for demodulation purposes in general, and thus an AI CE friendly equalizer may not be needed for the SRS CE. An AI CE friendly precoding matrix indication (PMI) selection may still be utilized in the post processing.

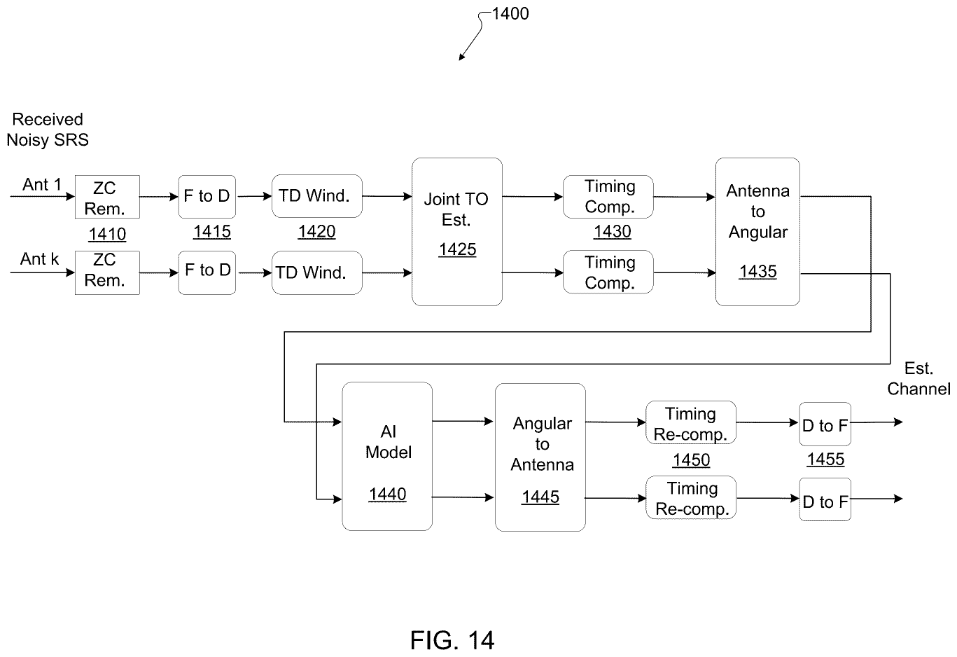

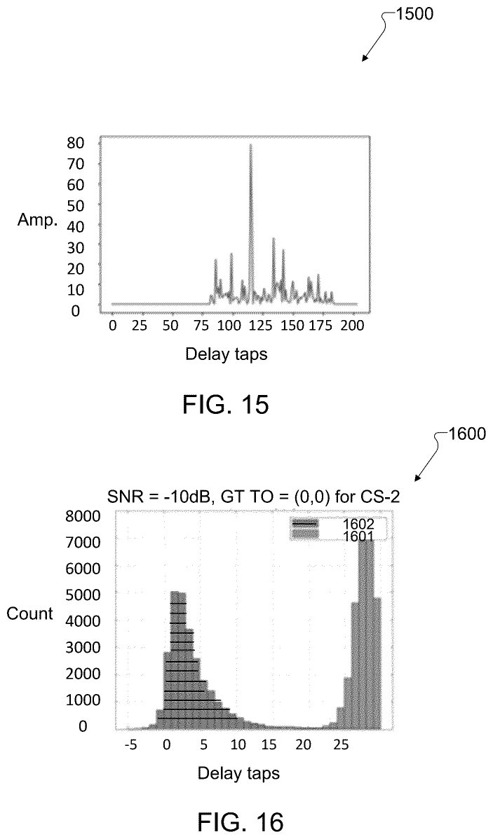

The end-to-end SRS AI CE architecture 1300 may outperform other possible variants, notably in terms of reducing the error floor. For example, this architecture may outperform a delay domain preprocessing alternative as shown in FIG. 14. Note that the delay domain pipeline may perform timing estimation in the delay domain by, e.g., finding the center of gravity as shown in FIG. 15.

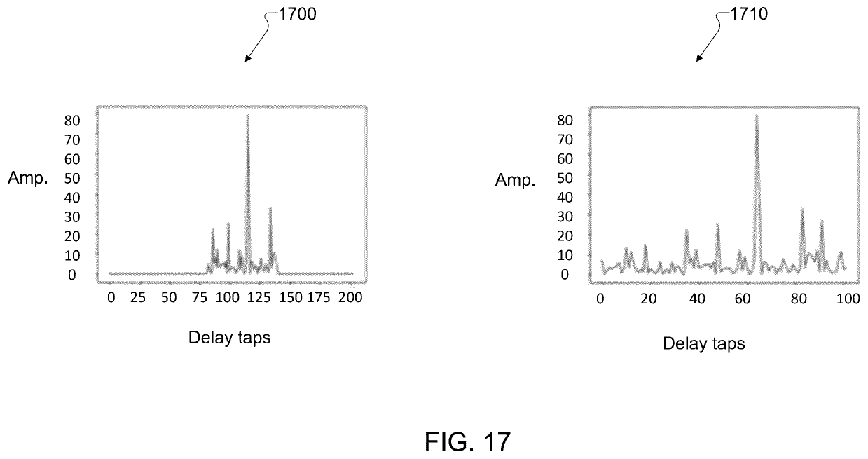

However, due to the MUI removal the center of gravity estimates may be biased as shown in FIGS. 15 and 16. Thus, a modified timing estimation algorithm in the delay domain may be utilized to first remove the zeroes after the MUI removal and then perform the timing estimation through the center of gravity or first balance zeroes on both sides before timing estimation as illustrated in FIG. 17.

FIG. 14 illustrates another example end-to-end architecture 1400 for SRS based AI CE in accordance with example embodiments of the present disclosure. The example architecture shown in FIG. 14 is for illustration only, and could have the same or similar configuration. One or more of the components illustrated in FIG. 14 may be implemented in specialized circuitry configured to perform the noted functions or one or more of the components may be implemented by one or more processors executing instructions to perform the noted functions. Other embodiments of the delay domain end-to-end architecture could be used without departing from the scope of this disclosure.

In the example as illustrated in FIG. 14, a ZC remover 1410 may remove a ZC sequence from the noisy SRS to obtain a least square noisy channel estimate. A converter 1410 may then convert the noisy channel estimate from the frequency domain to the delay domain by taking IFFT across the subcarriers. A time window 1420 may filter the transformed noisy channel using a time domain window. Through the timing domain window filtering, the target channel may be separated from the MUI in the delay domain. A TO estimator 1425 may perform joint TO estimation in the delay domain. A compensator 1430 may perform timing compensation and a converter 1435 may convert the noisy channel estimate from the antenna to angular domain. An AI model 1440 may denoise the delay domain noisy channel estimate. A converter 1445 may transform the denoised channel estimate from the angular domain to the antenna domain. A recompensator 1450 may perform timing recompensation and a converter 1455 may convert the denoised channel estimate from the delay domain to the frequency domain and output the channel estimate.

As previously mentioned, the example end-to-end architecture 1300 for SRS based CE of FIG. 13 may provide an improved CE performance as compared to the CE performance by this end-to-end architecture 1400.

FIGS. 15 and 16 illustrate example issues 1500, 1600 with a center of gravity (CoG) timing estimation algorithm in accordance with example embodiments of the present disclosure. The example issues shown in FIGS. 15 and 16 are for illustration only, and there may be different issues with the CoG timing estimation algorithm.

The CoG timing estimation algorithm may be performed as following:

$▯ Step 1 : Compute power delay profile for each antenna as {g}_{D \times 1}^{i} = {\vert {h}_{D \times 1}^{i} \vert}^{2} ,$
□ Step 2: Cyclically rotate each gⁱ by D/2 delay taps,
$▯ Step 3 : Estimate CoG : {Ω}_{i} = \frac{{\sum }_{d = 0}^{D} d {g}^{i} [ d ]}{{\sum }_{d = 0}^{D} {g}^{i} [ d ]} ∀ i ∈ \{ 1 , 2 , … , N \}$
□ Output: timing estimate given by
$τ = round ( \frac{1}{N} {\sum }_{i = 1}^{N} {Ω}_{i} - \frac{D}{2} )$

However, due to the bias created by the MUI removal window, there may be issues with the CoG timing estimation as shown in FIGS. 15 and 16.

In FIG. 15, due to the MUI removal window, the zeroed-out taps may not be symmetric around tap 102 after the FFT shift operation in Step 2 above. This issue may result in overestimating CoG significantly.

In FIG. 16, the ground truth may be 0 TA and the delay domain TO estimates 1601 may be worse than the frequency domain TO estimates 1602. This may render plainly adopting delay domain preprocessing risky over the AI friendly preprocessing which utilizes frequency TO.

FIG. 17 illustrates example modified CoG timing estimation algorithms 1700, 1710 in accordance with example embodiments of the present disclosure. The example modified algorithms shown in FIG. 17 are for illustration only, and could have the same or similar configurations. Other embodiments of the modified CoG timing estimation algorithms could be used without departing from the scope of this disclosure.

Modified algorithm 1700 as shown in FIG. 17 may be performed by adding additional zeroes to the tail to try to balance out zeroes on either side of tap 102. A design criterion for the modified algorithm 1700 may include an assumption that operation domain supports ±nTA and accordingly the signal beyond what is supported as CoG estimate may be cut.

Modified algorithm 1710 as shown in FIG. 17 may be performed by removing zeroes in the signal before performing CoG estimation.

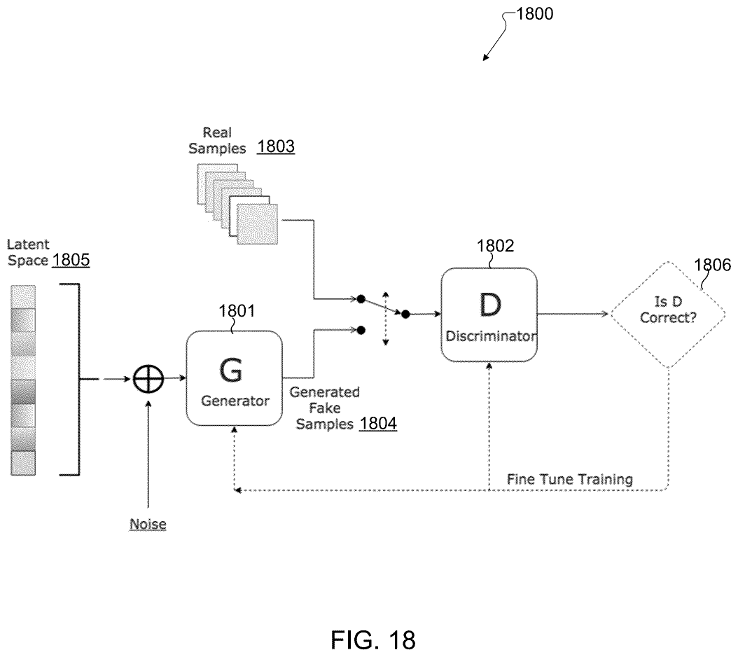

FIG. 18 illustrates an example generative adversarial network (GAN) 1800 to aid with the AI CE model deployment in the wireless communication systems in accordance with example embodiments of the present disclosure. The example GAN shown in FIG. 18 is for illustration only, and could have the same or similar configuration. One or more of the components illustrated in FIG. 18 may be implemented in specialized circuitry configured to perform the noted functions or one or more of the components may be implemented by one or more processors executing instructions to perform the noted functions. Other embodiments of the GAN could be used without departing from the scope of this disclosure.

For the fast widespread adoption of the AI CE model for PUSCH or SRS pilots, different tools may be utilized. An example first tool may forecast the sites where AI CE model may be successfully deployed. An example second tool may forecast the sites where the operator may benefit for an FPGA implementation of the AI CE model as compared to a GPU based implementation. An example use case(s) for motivating the forecasting tools or methods of procedure (MOP) may be as following:
An operator deploys an AI CE model on certain example sites involving human intervention for tuning the preprocessing, postprocessing and AI CE model to make the AI CE model work better than the previous non-AI deployment
This process may be costly to operators, and thus the cost may be minimized for the widespread adoption
FPGA based AI model may be less expensive and more energy efficient to deploy than GPU based AI model, and thus identifying which option to deploy for new sites may be made.

Example Tool 1: Given an example AI CE model on certain sites and failures on some other sites, a tool that predicts which other sites have higher chances of success may be helpful. The tool may first compare a few different KPIs in order to compare input data distribution to the AI CE model of the sites where the AI CE model can operate with the input data distribution of a candidate site. For instance, some metrics may include (a) a peak power distribution, (b) a distribution of an excess delay, (c) a distribution of an angular spread at the input to the AI CE model. If the distance between all of the computed distributions is less than required thresholds for each, then success of the AI CE model on that site may be forecasted. The distributions may be computed for different time windows and weekdays and/or weekends. This may be because at different times of the day different distributions of the KPIs at the input to the AI model may be expected.

Example Tool 2: the AI CE model may be implemented using a GPU or an FPGA. The FPGA based AI CE model may have an advantage in terms of energy efficiency as its implementation is highly customized for the architecture. The GPU based AI CE may be implemented for more general purposes, but suffer in terms of energy efficiency. Hence, a tool for forecasting that the AI CE model on a site may be FPGA based or GPU based may be utilized in accordance with the present disclosure. The forecasting may be made by computing a likelihood score. The likelihood score may be a measure of the expected stability of the distributions. For instance, in an environment where the user traffic may change notably at different times of, e.g., a year, it may be difficult to have a fixed FPGA based AI CE implementation since making updates to the architecture may become challenging. In these cases, a GPU based implementation may be preferred since the GPU based implementation may easily allow swapping a different AI CE model if needed at different times in the year. However, for sites where the input distribution to the AI CE model is considered fairly repeatable at different long-term intervals, the FPGA based implementations may be forecasted to be successful and help conserve energy.

A detailed technical description of combining both tools may be as following:
Collect channel data (power delay profile) for each PoC site over a long period of more than K weeks (K>=2)
Divide a day into time windows (e.g., 3 windows: 9 am-6 pm working hours; 6 pm to 11 pm for post work hours; and 11 pm to 9 am for relatively less busy hours).
Compute data distribution per time window per day in terms of a given list of KPIs (e.g., peak power distribution in a power delay profile, a location of peak in the power delay profile, an angular spread per delay tap, etc.)
Classify sites where across different weeks, the data distribution a given time window in the week is pseudo stationary (little to no change) versus dynamic (a significant amount of changes). This may be performed with human intervention or by quantifying computing mean and standard deviation of the KPIs in time windows and taking a difference to quantify the change, along with thresholds to classify pseudo stationary or dynamic.
Train GANs (e.g., the GAN 1700) to generate channel samples for each given PoC site
Recommend a new candidate site if the discriminator of any PoC site is unable to distinguish the distribution of channel samples of the new site from the channel samples of the PoC site
Recommend FPGA based installation if the corresponding PoC site is declared pseudo stationary
Recommend GPU based installation if the corresponding PoC site is declared dynamic
Recommend the same preprocessing and AI model architecture for the new candidate site as the corresponding PoC site.

The example GAN 1800 as shown in FIG. 18 may include a generator 1801 and a discriminator 1802. The input to the discriminator 1802 may be real channel samples 1803 and the output 1804 from the generator 1801 which may mimic the distribution of the real samples by converting vectors from a latent space 1805 into dummy channel samples 1804. If the discriminator 1802 is determined to be correct at operation 1806, then the AI model may be deployed at the new candidate site. That is, if the discriminator 1802 is unable to distinguish the distribution of the real channel samples 1803 from the new candidate site with the distribution of the dummy channel samples 1804, the new candidate site may be recommended for deployment of the AI model for AI CE. The GAN 1800 may then be trained for fining tuning.

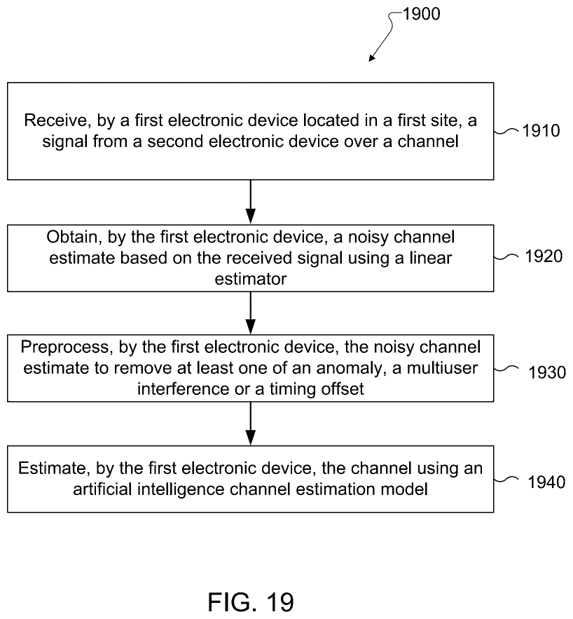

FIG. 19 illustrates an example flow chart for an AI-aided channel estimation method 1900 according to embodiments of the present disclosure. An embodiment of the method illustrated in FIG. 19 is for illustration only. One or more of the components illustrated in FIG. 19 may be implemented in specialized circuitry configured to perform the noted functions or one or more of the components may be implemented by one or more processors executing instructions to perform the noted functions. Other embodiments of data preparation could be used without departing from the scope of this disclosure.

As illustrated in FIG. 19, the method 1900 begins at step 1910. At step 1910, a first electronic device (e.g., a base station 101-103 of FIGS. 1 and 2) may receive a signal from a second electronic device (e.g., a UE 111-106 of FIGS. 1 and 3) on a channel.

At step 1920, the first electronic device may obtain a noisy channel estimate based on the received signal using a linear estimator.

At step 1930, the first electronic device may preprocess the noisy channel estimate to remove at least one of an anomaly, an MUI, or a TO.

In one embodiment, the noisy channel estimate may be preprocessed by applying CFAR to identify the anomaly in noisy channel data, and mitigating the anomaly by correcting the noisy channel data or removing the noisy channel data with the anomaly, separating multiplexed data streams using a multi-CS separator, obtaining a TO estimate and compensation for each of the separated multiplexed data streams, applying a time window on the noisy channel estimate to remove the MUI and denoise the noisy channel estimate, the time window adaptive to the TO estimate, and performing power normalization to the noisy channel estimate.

At step 1940, the first electronic device may estimate the channel using an AI CE model.

In one embodiment, the estimated channel output from the AI CE model may be postprocessed. The estimated channel may be postprocessed by applying power denormalization and timing recompensation, determining equalizer weights using the estimated channel for each pilot symbol, and performing equalization of data symbols using a time domain linear interpolation of the equalizer weights.

In one embodiment, the AI CE model may be trained using transfer learning. The transfer learning may include training the AI CE model with synthetic data, freezing layers of the AI CE model, and training unfrozen layers of the AI CE model using field data.

In one embodiment, the AI CE model may be trained by generating a first label and a second label. The AI CE model may be further trained by applying the first label as a primary label for training and the second label as a secondary label for testing based on a domain expertise, applying the first label and the second label in alternate epochs, or computing a noise floor of the estimated channel using a power delay profile and selecting the first label or the second label as the primary label based on the noise floor.

In one embodiment, the AI CE model may be trained by a loss function including a sum of a first loss function and a second loss function, the first loss function minimizing a distance of the estimated channel with a perfect channel, the second loss function dependent on a modulation constellation and multiplied by a weighting function.

In one embodiment, the AI CE model may be deployed at a new site by collecting channel data for the new site over a predefined period, training a GAN to generate channel samples for the first site over at least one portion of the predefined period, dividing the at least one portion of the predefined period into a plurality of time windows, computing a data distribution per time window over the at least one portion of the predefined period for the channel data and the channel samples based on key performance indicators, comparing the channel data for the new site with the channel samples for the first site, and deploying the AI CE model at the new site based on an inability of a discriminator of the GAN to distinguish the data distribution of the channel data of the new site from the data distribution of the channel samples of the first site.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims. None of the description in this application should be read as implying that any particular element, step, or function is an essential element that must be included in the claim scope. The scope of patented subject matter is defined only by the claims.

What is claimed is:

1. A method comprising:
receiving, by a first electronic device located in a first site, a signal from a second electronic device over a channel;
obtaining, by the first electronic device, a noisy channel estimate based on the received signal using a linear estimator;
preprocessing, by the first electronic device, the noisy channel estimate to remove at least one of an anomaly, a multiuser interference (MUI), or a timing offset (TO); and
estimating, by the first electronic device, the channel using an artificial intelligence channel estimation (AI CE) model.

2. The method of claim 1, wherein preprocessing the noisy channel estimate comprises:
applying constant false-alarm rate (CFAR) to identify the anomaly in noisy channel data, and mitigating the anomaly by correcting the noisy channel data or removing the noisy channel data with the anomaly;
separating multiplexed data streams using a multi-cyclic shift (CS) separator;
obtaining a TO estimate and compensation for each of the separated multiplexed data streams;
applying a time window on the noisy channel estimate to remove the MUI and denoise the noisy channel estimate, the time window adaptive to the TO estimate; and
performing power normalization to the noisy channel estimate.

3. The method of claim 1, further comprising:
postprocessing, by the first electronic device, the estimated channel output from the AI CE model;
wherein postprocessing the estimated channel comprises:
applying power denormalization and timing recompensation;
determining equalizer weights using the estimated channel for each pilot symbol; and
performing equalization of data symbols using a time domain linear interpolation of the equalizer weights.

4. The method of claim 1, wherein:
the AI CE model is trained using transfer learning; and
the transfer learning comprises:
training the AI CE model with synthetic data;
freezing layers of the AI CE model; and
training unfrozen layers of the AI CE model using field data.

5. The method of claim 1, wherein the AI CE model is trained by:
generating a first label and a second label; and
one of:
applying the first label as a primary label for training and the second label as a secondary label for testing based on a domain expertise;
applying the first label and the second label in alternate epochs; or
computing a noise floor of the estimated channel using a power delay profile and selecting the first label or the second label as the primary label based on the noise floor.

6. The method of claim 1, wherein the AI CE model is trained by a loss function including a sum of a first loss function and a second loss function, the first loss function minimizing a distance of the estimated channel with a perfect channel, the second loss function dependent on a modulation constellation and multiplied by a weighting function.

7. The method of claim 1, wherein the AI CE model is deployed at a new site by:
collecting channel data for the new site over a predefined period;
training a generative adversarial network (GAN) to generate channel samples for the first site over at least one portion of the predefined period;
dividing the at least one portion of the predefined period into a plurality of time windows;
computing a data distribution per time window over the at least one portion of the predefined period for the channel data and the channel samples based on key performance indicators;
comparing the channel data for the new site with the channel samples for the first site; and
deploying the AI CE model at the new site based on an inability of a discriminator of the GAN to distinguish the data distribution of the channel data of the new site from the data distribution of the channel samples of the first site.

8. A first electronic device located in a first site, the first electronic device comprising:
memory; and
a processor operably coupled to the memory, the processor configured to:
receive a signal from a second electronic device over a channel;
obtain a noisy channel estimate based on the received signal using a linear estimator;
preprocess the noisy channel estimate to remove at least one of an anomaly, a multiuser interference (MUI), or a timing offset (TO); and
estimate the channel using an artificial intelligence channel estimation (AI CE) model.

9. The first electronic device of claim 8, wherein to preprocess the noisy channel estimate, the processor is further configured to:
apply constant false-alarm rate (CFAR) to identify the anomaly in noisy channel data, and mitigating the anomaly by correcting the noisy channel data or removing the noisy channel data with the anomaly;
separate multiplexed data streams using a multi-cyclic shift (CS) separator;
obtain a TO estimate and compensation for each of the separated multiplexed data streams;
apply a time window on the noisy channel estimate to remove the MUI and denoise the noisy channel estimate, the time window adaptive to the TO estimate; and
perform power normalization to the noisy channel estimate.

10. The first electronic device of claim 8, wherein:
the processor is further configured to postprocess the estimated channel output from the AI CE model, and
to postprocess the estimated channel, the processor is further configured to:
apply power denormalization and timing recompensation;
determine equalizer weights using the estimated channel for each pilot symbol; and
perform equalization of data symbols using a time domain linear interpolation of the equalizer weights.

11. The first electronic device of claim 8, wherein:
the AI CE model is trained using transfer learning; and
the transfer learning comprises:
training the AI CE model with synthetic data;
freezing layers of the AI CE model; and
training unfrozen layers of the AI CE model using field data.

12. The first electronic device of claim 8, wherein the AI CE model is trained by:
generating a first label and a second label; and
one of:
applying the first label as a primary label for training and the second label as a secondary label for testing based on a domain expertise;
applying the first label and the second label in alternate epochs; or
computing a noise floor of the estimated channel using a power delay profile and selecting the first label or the second label as the primary label based on the noise floor.

13. The first electronic device of claim 8, wherein the AI CE model is trained by a loss function including a sum of a first loss function and a second loss function, the first loss function minimizing a distance of the estimated channel with a perfect channel, the second loss function dependent on a modulation constellation and multiplied by a weighting function.

14. The first electronic device of claim 8, wherein the AI CE model is deployed at a new site by:
collecting channel data for the new site over a predefined period;
training a generative adversarial network (GAN) to generate channel samples for the first site over at least one portion of the predefined period;
dividing the at least one portion of the predefined period into a plurality of time windows;
computing a data distribution per time window over the at least one portion of the predefined period for the channel data and the channel samples based on key performance indicators;
comparing the channel data for the new site with the channel samples for the first site; and
deploying the AI CE model at the new site based on an inability of a discriminator of the GAN to distinguish the data distribution of the channel data of the new site from the data distribution of the channel samples of the first site.

15. A non-transitory computer readable medium embodying a computer program, the computer program comprising program code that, when executed by a processor of a first electronic device, causes the first electronic device to:
receive a signal from a second electronic device over a channel;
obtain a noisy channel estimate based on the received signal using a linear estimator;
preprocess the noisy channel estimate to remove at least one of an anomaly, a multiuser interference (MUI), or a timing offset (TO); and
estimate the channel using an artificial intelligence channel estimation (AI CE) model.

16. The non-transitory computer readable medium of claim 15, wherein the program code that, when executed by the processor of the first electronic device, causes the first electronic device to preprocess the noisy channel estimate comprises program code that, when executed by the processor of the first electronic device, causes the first electronic device to:
apply constant false-alarm rate (CFAR) to identify the anomaly in noisy channel data, and mitigating the anomaly by correcting the noisy channel data or removing the noisy channel data with the anomaly;
separate multiplexed data streams using a multi-cyclic shift (CS) separator;
obtain a TO estimate and compensation for each of the separated multiplexed data streams;
apply a time window on the noisy channel estimate to remove the MUI and denoise the noisy channel estimate, the time window adaptive to the TO estimate; and
perform power normalization to the noisy channel estimate.

17. The non-transitory computer readable medium of claim 15, wherein:
the AI CE model is trained using transfer learning; and
the transfer learning comprises:
training the AI CE model with synthetic data;
freezing layers of the AI CE model; and
training unfrozen layers of the AI CE model using field data.

18. The non-transitory computer readable medium of claim 15, wherein the AI CE model is trained by:
generating a first label and a second label; and
one of:
applying the first label as a primary label for training and the second label as a secondary label for testing based on a domain expertise;
applying the first label and the second label in alternate epochs; or
computing a noise floor of the estimated channel using a power delay profile and selecting the first label or the second label as the primary label based on the noise floor.

19. The non-transitory computer readable medium of claim 15, wherein the AI CE model is trained by a loss function including a sum of a first loss function and a second loss function, the first loss function minimizing a distance of the estimated channel with a perfect channel, the second loss function dependent on a modulation constellation and multiplied by a weighting function.

20. The non-transitory computer readable medium of claim 15, wherein the AI CE model is deployed at a new site by:
collecting channel data for the new site over a predefined period;
training a generative adversarial network (GAN) to generate channel samples for the first site over at least one portion of the predefined period;
dividing the at least one portion of the predefined period into a plurality of time windows;
computing a data distribution per time window over the at least one portion of the predefined period for the channel data and the channel samples based on key performance indicators;
comparing the channel data for the new site with the channel samples for the first site; and
deploying the AI CE model at the new site based on an inability of a discriminator of the GAN to distinguish the data distribution of the channel data of the new site from the data distribution of the channel samples of the first site.
